(19) United States
(12) Patent Application Publication
(10) Pub. No.: US 2011/0080877 A1
(43) Pub. Date: Apr. 7, 2011

(54) Variable single carrier frequency division multiple access (SC-FDMA) coding

(75) Inventor: Markus Nentwig, Helsinki (FI)

(73) Assignee: Nokia Corporation

(21) Appl. No.: 12/588,118

(22) Filed: Oct. 5, 2009

(51) Int. Cl. H04W 72/04

(52) U.S. Cl. 370/329

(57) ABSTRACT

A method can include applying a first modulation and coding scheme to a first part of a symbol, applying a second modulation and coding scheme to a second part of the symbol, and combining the first part of the symbol and the second part of the symbol to form the symbol to be transmitted. The first modulation and coding scheme differs from the second modulation and coding scheme and wherein the first part of the symbol is temporally different from the second part of the symbol.

### CROSS REFERENCE TO RELATED APPLICATIONS

This application does not claim the priority of any other applications.

### BACKGROUND

1. Field

Communication of information in an environment in which the signals must compete with a significant amount of interference or noise is discussed particularly, for example, in the context of mobile wireless devices and network infrastructure. Techniques, systems, and other technology for providing variable single-carrier frequency division multiple access (SC-FDMA) coding are presented, which may be relevant to wireless mobile devices and high-volume network infrastructure, and related components (chipsets).

2. Description of the Related Art

Local-area optimized wireless systems aim to provide high data rates in comparatively small cells. SC-FDMA is a candidate for a modulation format (used in the uplink in Long Term Evolution (LTE) of the Third Generation (3G) network), because it allows efficient power amplification of a single data stream, resulting effectively in a larger coverage area than traditionally achieved with an Orthogonal Frequency Division Multiplexing (OFDM) transmitter having the same power amplifier. SC-FDMA also has other properties that make it interesting, like the ability to deal with time-varying interference, as shown below.

### SUMMARY

One embodiment of the present invention is a method including applying a first modulation and coding scheme to a first part of a symbol. The method also includes applying a second modulation and coding scheme to a second part of the symbol. The method further includes combining the first part of the symbol and the second part of the symbol to form the symbol to be transmitted. The first modulation and coding scheme differs from the second modulation and coding scheme and the first part of the symbol is temporally different from the second part of the symbol.

An other embodiment of the present invention is an apparatus including at least one memory including computer program code, and at least one processor. The at least one memory and the computer program code are configured to, with the at least one processor, cause the apparatus at least to perform the following: apply a first modulation and coding scheme to a first part of a symbol, apply a second modulation and coding scheme to a second part of the symbol, and combine the first part of the symbol and the second part of the symbol to form the symbol to be transmitted. The first modulation and coding scheme differs from the second modulation and coding scheme and wherein the first part of the symbol is temporally different from the second part of the symbol.

An additional embodiment of the present invention is an apparatus. The apparatus includes first applying means for applying a first modulation and coding scheme to a first part of a symbol. The apparatus also includes second applying means for applying a second modulation and coding scheme to a second part of the symbol. The apparatus further includes combining means for combining the first part of the symbol and the second part of the symbol to form the symbol to be transmitted. The first modulation and coding scheme differs from the second modulation and coding scheme and the first part of the symbol is temporally different from the second part of the symbol.

Yet another embodiment of the present invention is a computer-readable storage medium encoded with instructions that, when executed on a particular device, perform a process. The process includes applying a first modulation and coding scheme to a first part of a symbol. The process also includes applying a second modulation and coding scheme to a second part of the symbol. The process further includes combining the first part of the symbol and the second part of the symbol to form the symbol to be transmitted. The first modulation and coding scheme differs from the second modulation and coding scheme and the first part of the symbol is temporally different from the second part of the symbol.

Another embodiment of the present invention is a method. The method includes estimating a time-varying signal-to-noise ratio over at least one predetermined time interval of a transmission symbol at a receiver, relative to a start of the transmission symbol, to yield an estimate. The method also includes initiating transmission of the estimate to a transmitter at an opposite end of a communication link from the receiver.

A further embodiment of the present invention is an apparatus. The apparatus includes at least one memory including computer program code, and at least one processor. The at least one memory and the computer program code are configured to, with the at least one processor, cause the apparatus at least to perform the following: estimate a time-varying signal-to-noise ratio over at least one predetermined time interval of a transmission symbol, relative to a start of the transmission symbol, to yield an estimate, and initiate transmission of the estimate to a transmitter at an opposite end of a communication link from the apparatus.

An additional embodiment of the present invention is an apparatus. The apparatus includes estimating means for estimating a time-varying signal-to-noise ratio over at least one predetermined time interval of a transmission symbol, relative to a start of the transmission symbol, at a receiver to yield an estimate. The apparatus also includes initiating means for initiating transmission of the estimate to a transmitter at an opposite end of a communication link from the receiver.

Yet another embodiment of the present invention is a computer-readable storage medium encoded with instructions that, when executed on a particular device, perform a process. The process includes estimating a time-varying signal-to-noise ratio over at least one predetermined time interval of a transmission symbol, relative to a start of the transmission symbol, at a receiver to yield an estimate. The process also includes initiating transmission of the estimate to a transmitter at an opposite end of a communication link from the receiver.

### BRIEF DESCRIPTION OF THE DRAWINGS

For proper understanding of the invention, reference should be made to the accompanying drawings, wherein:

FIG. 1 illustrates time-varying Intersymbol Interference (ISI) for five different channel realizations (PedB channel);

FIG. 2 illustrates time-varying Intersymbol Interference (ISI) for five different channel realizations (VehA channel);

FIG. 3 illustrates time-varying ISI, averaged over many channel realizations;

FIG. 4 illustrates mapping of Signal to Noise Ratio (SNR) to throughput (PedB example);

FIG. 5 illustrates mapping of SNR to throughput (VehA example);

FIG. 6a illustrates a transmission symbol on a time axis;

FIG. 6b illustrates the impulse response of a radio channel;

FIG. 6c illustrates a reception window;

FIG. 6d illustrates the location of a part of a first data stream;

FIG. 7 illustrates the anatomy of a transmission symbol;

FIG. 8 illustrates the relationship between an information symbol and a modulation symbol;

FIG. 9 illustrates an example for a transmit parameter vector;

FIG. 10 illustrates the relationship between the Shannon limit and modulation-and-coding schemes;

FIG. 11 illustrates the concept of water filling;

FIG. 12 illustrates intersymbol interference before equalization;

FIG. 13 illustrates the effect of equalizer impulse response on intersymbol interference;

FIG. 14 illustrates an apparatus according to an embodiment of the present invention;

FIG. 15 illustrates an SC-FDMA transmitter;

FIG. 16 illustrates a transmitter according to certain embodiments of the present invention;

FIG. 17 illustrates the composition of a transmission symbol according to an embodiment of the present invention;

FIG. 18 illustrates a method according to an embodiment of the present invention; and

FIG. 19 illustrates another method according to an embodiment of the present invention.

### DETAILED DESCRIPTION

In certain embodiments of the present invention, within one transmission symbol different modulation-and-coding schemes are used for different parts of the symbol. The transmission symbol may be an SC-FDMA symbol. The modulation-and-coding scheme for a part of the symbol is, in such embodiments, chosen according to the estimated signal-to-noise ratio in that part of the symbol. The selection of a modulation scheme, such as Quadrature Phase Shift Keying (QPSK), 16 point Quadrature Amplitude Modulation (16QAM), 64 point QAM (64QAM), or the like, and coding scheme, such as uncoded, convolutional, or Turbo code with an appropriate puncturing pattern can be based on a transmission parameter vector, which may also control the signal amplitude and transmit power level.

Reason to use SC-FDMA instead of OFDM include the single-carrier properties of the signal, such as a well-controlled peak-to-average ratio, enabling energy-efficient power amplification. The signal may be assigned to a set of predetermined subcarriers using subcarrier mapping (SC). Subcarrier mapping may be performed in a manner that preserves the single-carrier properties of the signal. Further, subcarrier mapping may be restricted to operations that preserve a specific time relationship between input and output samples. This means that, for a known subcarrier mapping operation, the location of any input sample in the length of the symbol body is also known.

As will be discussed below, different parts of the symbol body are affected differently by intersymbol interference, that is to say by one symbol interfering with another symbol. Therefore, an individual modulation-and-coding scheme can be used for each part of the symbol, choosing one that is most appropriate for a given signal-to-noise ratio in the part of the symbol. Signal-to-noise ratio (SNR) refers to the ratio of a wanted signal's power, relative to the power of all unwanted signal components. Unwanted signal components can be for example channel noise, receiver noise, transmitter distortion, interference from other transmitters, intersymbol interference, etc. Thus, SNR as used herein may be similar to Signal-to-Noise-plus-Interference Ratio (SNIR).

In channel-dependent scheduling and in general power allocation via waterfilling, individual modulation-and-coding schemes are assigned for different parts of the signal located at different frequencies. In contrast, in certain embodiments of the present invention, individual modulation-and-coding schemes are assigned to different parts of the signal located at different times relative to a symbol boundary.

Typically, part of the symbol is replicated in a cyclic prefix. For a channel impulse response that is shorter than the cyclic prefix duration, OFDM/SC-FDMA symbols can be separated at the receiver. If the channel time spread exceeds the cyclic prefix duration, the OFDM/SC-FDMA symbols can leak into each other resulting in what is known as intersymbol interference. Under such circumstances, intersymbol interference tends to be localized in the OFDM/SC-FDMA symbol. Specifically, the head and tail of each symbol are affected more than the middle of each symbol. Equalization at the receiver spreads out intersymbol interference somewhat, still it tends to remain largely concentrated at the head and the tail.

An alternative to a cyclic prefix is the use of a “guard interval” or “guard period,” where replication of a part of the symbol at the transmitter is avoided. While this text refers to “cyclic prefix” and “cyclic prefix length” for clarity, the same concept is applicable to guard periods and guard period length. Thus, the present invention should not be viewed as being limited to embodiments in which cyclic prefixes (in the strict sense of the term) are used.

Cyclic prefix length is a design parameter for a radio system. Its choice is based mainly on the expected channel conditions. Cyclic prefix length may be a fixed parameter, it may vary during the operation of the radio system or it may be dynamically configured. While an increased cyclic prefix length allows to resolve multipath propagation from channels with a higher delay spread, an excessively long CP requires channel capacity that becomes unavailable for data transmission. On the other hand, an excessively short CP leads to intersymbol interference. This mainly affects long links.

The following discussion provides some simulation results that illustrate the time-varying intersymbol interference (ISI) resulting from time-dispersive channels with delay spreads exceeding the cyclic prefix length. Here, ISI can refer specifically to leakage from parts of neighboring symbols that get dispersed in time by channel and filtering effects. A simulation was implemented wherein a stream of 100 SC-FDMA symbols and cyclic prefixes was generated. The stream was convolved with the channel impulse response. Additive white Gaussian noise (AWGN) was supplied. The receiver picked one FFT length, using the best possible FFT window aperture and the receiver applied FFT equalization. For each sample, the error was calculated and then the error was averaged for all 100 symbols. The above was averaged over 100 instantiations of the channel model, with fixed tap weights and random phase.

In this simulation, the frequency-domain equalizer was based on a known channel impulse response and known SNR (which equates to a perfect channel estimate). The subcarrier spacing was chosen as 60 kHz, equivalent to a symbol duration with one quarter the length used in LTE. The relative length of the CP was kept at 5%, equivalent to LTE. A linear minimum mean-square-error (LMMSE) equalizer was applied to the received signal, deteriorated by additive white Gaussian noise at a level of −40 dBc.

Three channel delay profiles, taken from the WCDMA/LTE specifications (TS 25.101) were used in the simulation. The first model was Pedestrian A, in which the impulse response length is 50% of the length of the cyclic prefix. The second model was Pedestrian B, in which the impulse response length is 445% of the length of the cyclic prefix. The third model was Vehicular A, in which the impulse response length is 301% of the length of the cyclic prefix.

Even in the absence of ISI, an equalizer cannot perfectly recover the signal-to-noise ratio due to the amplification of post-channel noise. To provide a reference result, equalizer performance was investigated in a first simulation round, where cyclic prefix length was extended to exceed the channel delay spread. For the Pedestrian A delay profile (PedA), a post-equalizer SNR of 39.4 dB results, which is 0.6 dB worse than the pre-equalizer SNR of 40 dB. For Pedestrian B (PedB), the post-equalizer SNR was 34.4 dB (5.6 dB loss), and for Vehicular A (VehA), 31.8 dB (8.2 dB loss). The above error is, in average, constant over the duration of a symbol. It is also very small, compared to ISI resulting from an insufficient CP length.

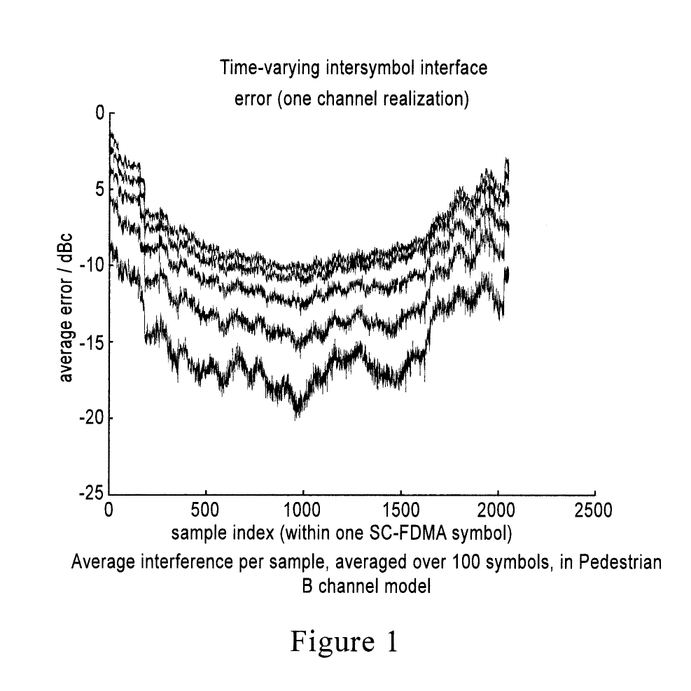

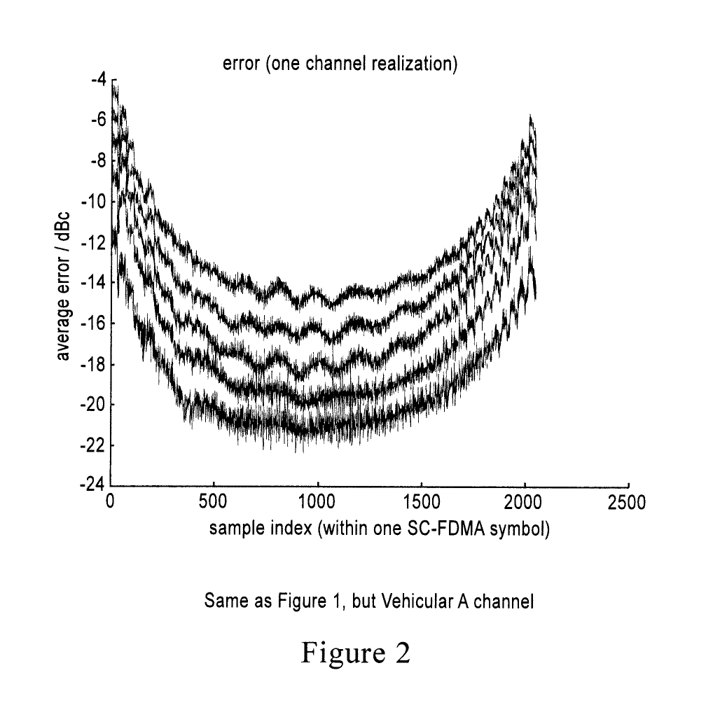

FIG. 1 shows the average post-equalizer SNR over the duration of a SC-FDMA symbol with 2048 samples, for the Pedestrian B delay profile, averaged over 100 symbols. The five distinct traces correspond to five simulation runs, each having an individual channel instantiation with random tap phases. The same was repeated in FIG. 2, using a “Vehicular A” channel delay profile.

According to FIG. 1 and FIG. 2, ISI is concentrated at the symbol edges. The overall ISI level varies considerably, depending on the channel realization. For a stationary or slowly moving device, the same channel will apply for a large number of subsequent transmission symbols.

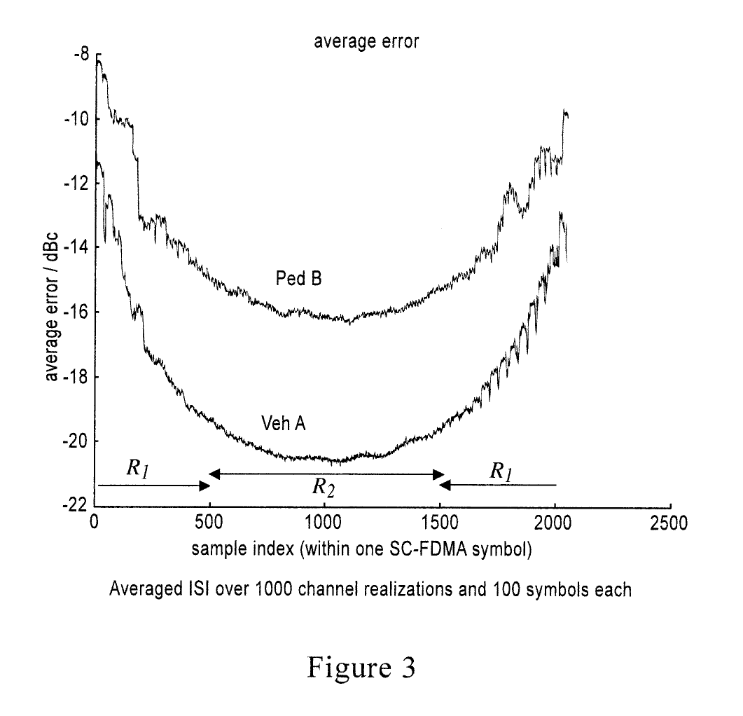

In FIG. 3, the results from FIGS. 1 and 2 were averaged over a large number of channel realizations. As can be seen in FIG. 3, ISI is concentrated at the symbol edges.

In one embodiment of the invention, the length of the symbol (shown on the horizontal axis of FIG. 3) is divided into two regions, R1 (the head and tail of the symbol) and R2 (the central section of the symbol). R1 and R2 are examples of predetermined time intervals. Then, individual modulation-and-coding schemes are assigned and individual transmit powers are assigned to each section.

As shown in FIG. 3, a vector of channel quality estimates may be −12.2 dB for R1 and −15.8 dB for R2. This may also be referred to as an error vector magnitude. The error level tends to scale with average transmit power, since the unwanted signal component is caused by a time-delayed copy of the previous symbol. The insufficient cyclic prefix length does not allow the receiver to wait for the end of the time-delayed copy, and some part of the previous symbol leaks into the reception window. Effectively it gets convolved with the impulse response of the equalizer. Since the equalizer is stable, the equalizer's impulse response always decays. Thus, the resulting ISI tends to be localized around the symbol edges even after equalization.

For the overall symbol, the simulated SNR (averaged over the whole length of the symbol) was 13.7 (PedB)/17.8 dB (VehA). The symbol can be divided, for example, into two regions R1 and R2, as illustrated in FIG. 3. As shown in the example of FIG. 3, for R1, the SNR was 12.2 (PedB)/16.2 dB (VehA). Similarly, for R2, the SNR was 15.8 (PedB)/20.2 dB (VehA).

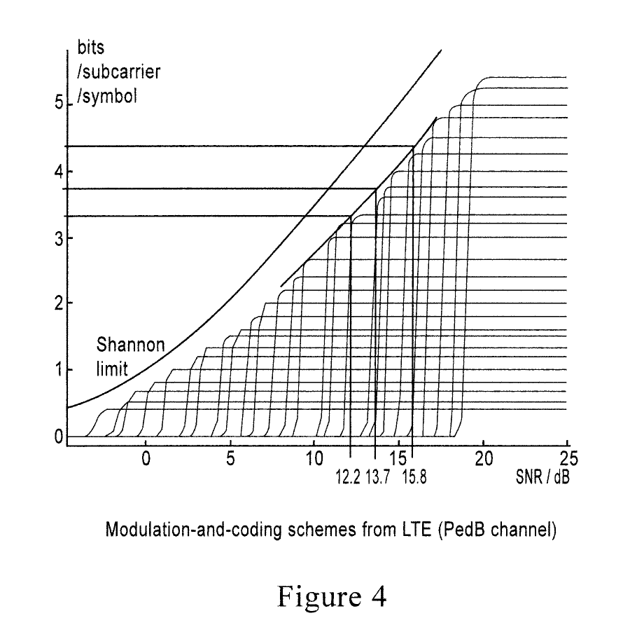

Each of those two regions were then assigned individual modulation-and-coding schemes (MCS), based on throughput curves for a set of available modulation-and-coding schemes as shown in FIG. 4. MCS can refer to a combination of modulation (for example, 16QAM), and coding parameters (for example, block length, coding scheme and puncturing pattern). The following throughput results for the PedB channel were obtained first with a single modulation-and-coding scheme for the whole length of the symbol and then with individual modulation-and-coding schemes for individual regions: The average SNR over full symbol duration (R1, R2 combined) was 3.75 bits/symbol/subcarrier; R₁ alone was 3.35 bits/symbol/subcarrier for half of the symbol duration; and R₂ alone was 4.4 bits/symbol/subcarrier for half of the symbol duration. By assigning individual modulation-and-coding schemes as is done in certain embodiments of the present invention, throughput increases from 3.75 to

$$\frac{3.35 + 4.4}{2} = 3.875 ,$$

a 3.3% improvement.

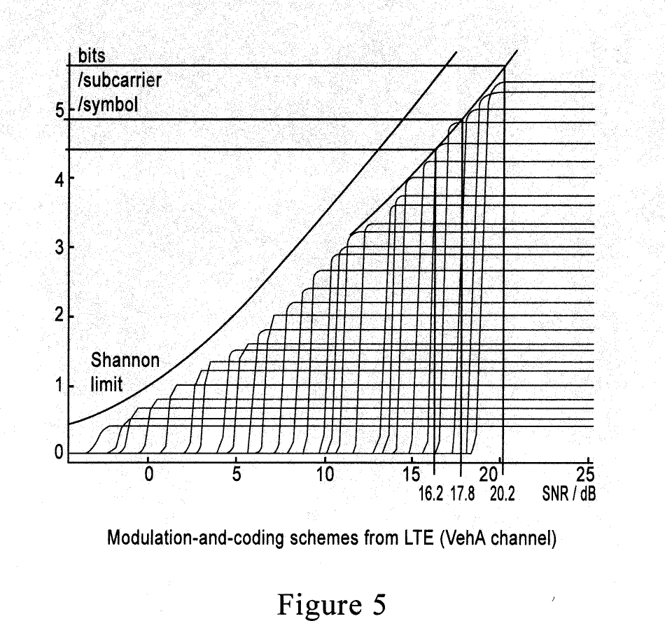

For the VehA channel (FIG. 5) the results were as follows: The average SNR over the full symbol duration (R1, R2 combined) was 4.85 bits/symbol/subcarrier. R1 alone was 4.4 bits/symbol/subcarrier for half of the symbol. R2 alone was 5.6 bits/symbol/subcarrier for half of the symbol. Thus, in this example, throughput increased from 4.85 to

$$\frac{4.4 + 5.6}{2} = 5.0 ,$$

a 3.1% improvement.

The simulation results above demonstrate that a communication link, such as a radio link, using certain embodiments of the present invention can perform better than conventional techniques on a channel whose impulse response exceeds the CP length. The radio link may already support multiple data streams (for example associated with different hybrid automatic repeat request (HARQ) processes). Therefore, the additional implementation effort associated with including certain embodiments of the present invention may be relatively small. Existing HARQ management may, in some embodiments, provide the SNR estimates.

Given the small additional complexity of the improvement, a typical performance improvement of 3% on channels with a delay spread exceeding the cyclic prefix length is quite substantial. By way of comparison, the whole cyclic prefix in LTE requires approximately 5% of capacity. Since the robustness against bad channels for distant users improves, the CP can be shortened to provide better performance to average users with a good channel. A reduction in CP length is particularly valuable when the length of the transmission symbol is decreased, since the number of cyclic prefixes per unit time increases. Thus, certain embodiments of the present invention may provide many benefits.

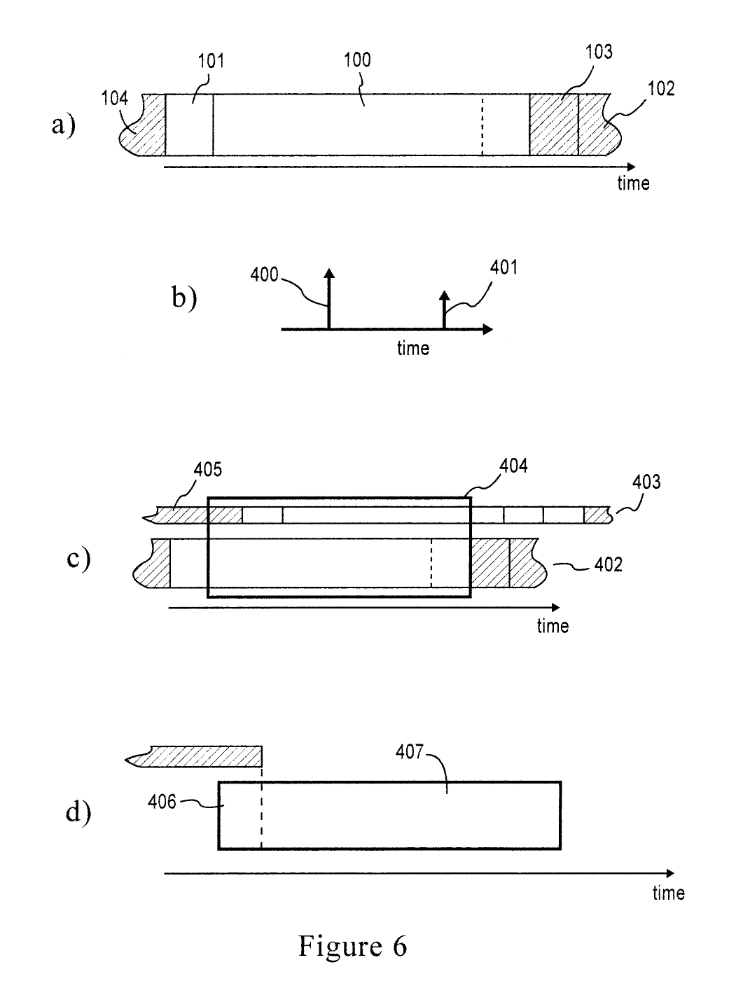

FIG. 6a illustrates a transmission symbol on a time axis. As shown in FIG. 6a, the end of a previous symbol 104 precedes cyclic prefix 101. After cyclic prefix 101 is the symbol body 100. After the symbol body 100 is the cyclic prefix of following symbol 103, followed by the symbol body of following symbol 102.

FIG. 6b illustrates the impulse response of a radio channel. The delay spread between line-of-sight component 400 and reflection 401 exceeds the length of the cyclic prefix 101.

FIG. 6c illustrates a reception window. In FIG. 6c, received signals 402 and 403 correspond to multipath components caused by channel taps 400 and 401. Only the sum of all multipath components is available at the receiver in this example. A conventional receiver may choose the receive window location 404 to maximize the SNR. Since the channel delay spread exceeds the cyclic prefix, the receiver cannot prevent intersymbol interference from the previous symbol 405 leaking into the receive window 404 of the present signal, thereby deteriorating SNR.

FIG. 6d illustrates the location of a part of a first data stream. According to one embodiment of the invention, the transmitter maps symbols belonging to a first data stream, encoded with a modulation-and-coding scheme for lower SNR, into the first part of the symbol 406. Further, it maps a second stream, modulated-and-coded for higher target SNR, into the second part of the symbol. The partition of the symbol and SNR estimates can be based on feedback from the receiver, obtained as a channel estimate.

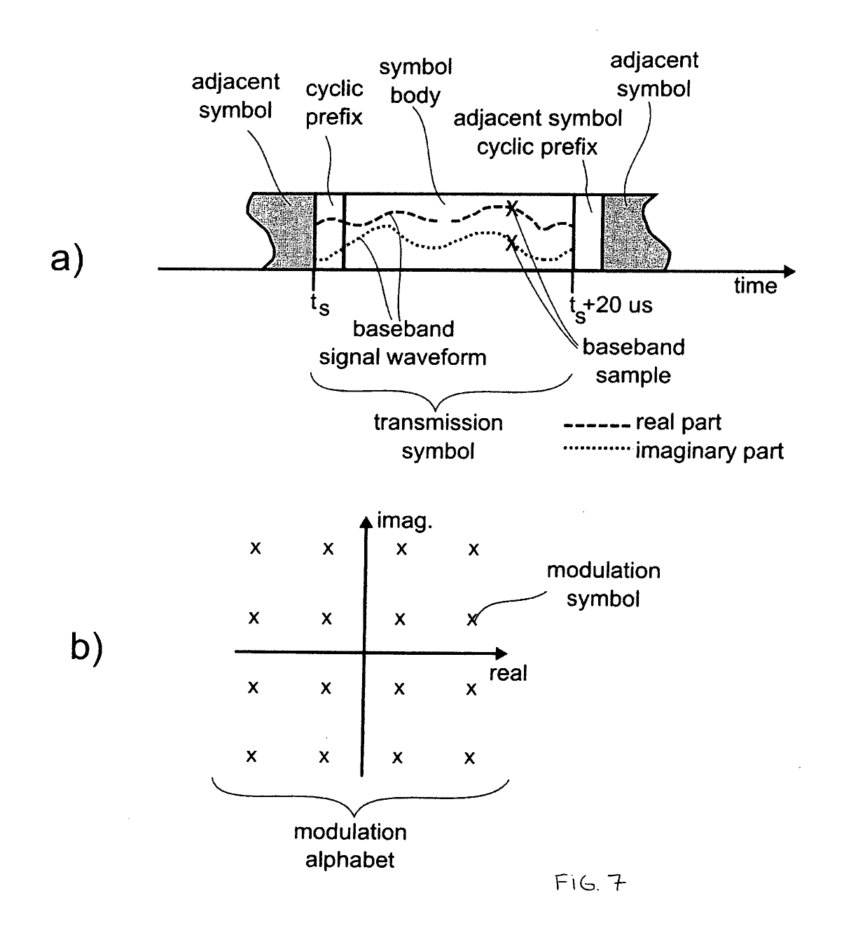

FIG. 7 illustrates the anatomy of a transmission symbol. As shown in FIG. 7, a transmission symbol can be composed of a cyclic prefix and a symbol body. Within the symbol body, there can be a modulation symbol “x” chosen from a modulation alphabet of a particular modulation and coding scheme, represented by a sample of a baseband waveform at a predetermined time instant. The waveform can include real and imaginary components. The transmission symbol can be located between two adjacent symbols.

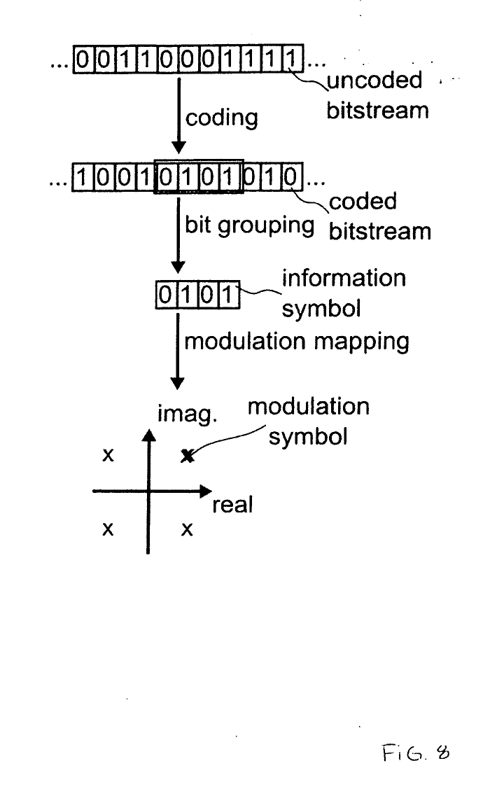

FIG. 8 illustrates the relationship between an information symbol and a modulation symbol. As can be seen in FIG. 8, a bitstream can be conceptually divided into information symbols. Those information symbols can than be mapped to modulation symbols of a modulation alphabet. The bitstream may be the result of a coding process.

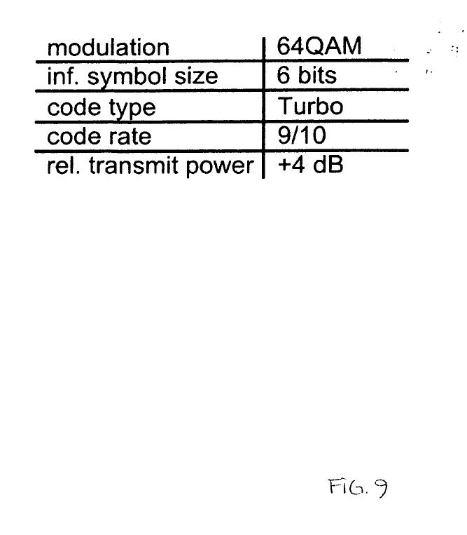

FIG. 9 presents an example for a transmission parameter vector. It may configure the transmission of a data stream to apply 9/10 turbo-coded 64QAM modulation using a relative transmit power of 4 dB for the targeted part of a transmission symbol.

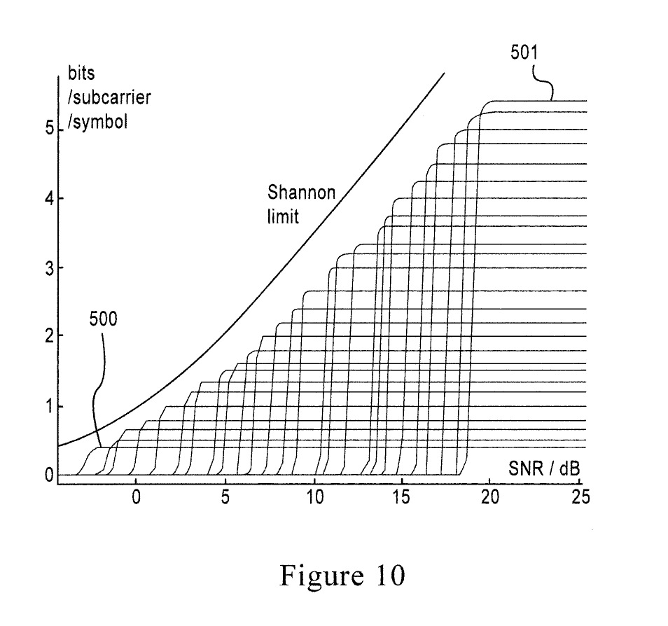

FIG. 10 illustrates the relationship between the Shannon limit and modulation-and-coding schemes. Assuming that a channel is affected only by additive white Gaussian noise, Shannon's capacity equation puts an ultimate limit to the amount of information that can be transmitted. Specifically, the capacity depends on signal-to-noise ratio (SNR). In a technical radio implementation, a modulation-and-coding scheme (MCS) is used for transmitting a signal in a form that is best suited for a particular channel. FIG. 10 provides an example for modulation-and-coding schemes from LTE. In FIG. 10, trace 500 represents heavily coded QPSK, whereas trace 501 represents almost uncoded 64QAM. As shown in the figure, for any given SNR, there is a single optimal MCS. Choosing a MCS that is too low (a curve that reaches its maximum on the left of a point on the SNR axis) results in less than the achievable throughput. In contrast, choosing a MCS that is too high usually results in no throughput at all, since the curves drop rather steeply.

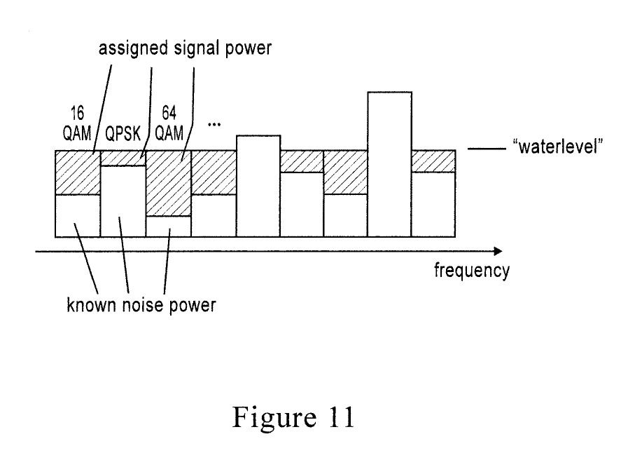

FIG. 11 illustrates the concept of water filling, which also sometimes referred to as “water pouring.” The water filling theorem is an established result from communications theory for a channel with variable SNR (for example variations in frequency). The theorem states that the sum of signal power plus noise power in any region should be equal, as long as it falls below a common “water level.” Since a different SNR results for every region, an individual modulation-and-coding scheme is chosen to maximize the amount of transmitted data. Estimates of noise strength, including intersymbol interference can help to govern both the assigned power level and the modulation-and-coding scheme.

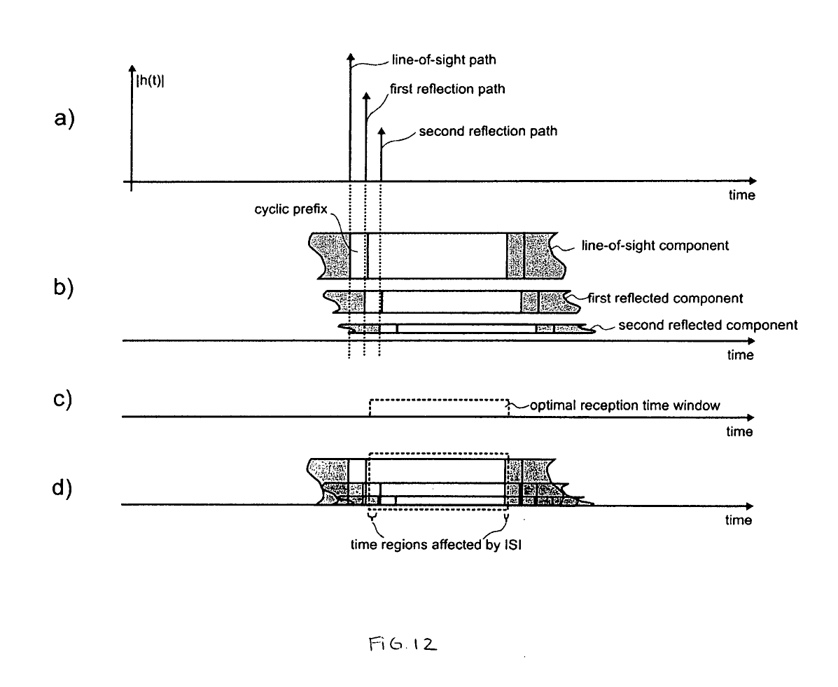

FIG. 12 illustrates intersymbol interference in a received signal before equalization. FIG. 12 a illustrates the delay profile of a radio channel. A line-of-sight path and two reflected paths cause time dispersion on the signal. This is shown in FIG. 12b, where a line-of-sight component of the transmitted signal is received simultaneously with two delayed components, corresponding to the channel delay profile in FIG. 12a. The transmitted signal contains a transmission symbol preceded and followed by two adjacent transmission symbols (shaded areas). FIG. 12c shows an optimum reception time window that maximizes the quality of the received signal, and FIG. 12d presents the individual signal components falling into the optimum receive window. Since the channel delay spread in FIG. 12a exceeds the length of the cyclic prefix, it is conventionally impossible to choose a reception window that does not include at least part of the preceding and following transmission symbol. As a result, the signal within the receive window is deteriorated by intersymbol interference, as shown in FIG. 12d. Intersymbol interference tends to be localized at start and end of the receive window.

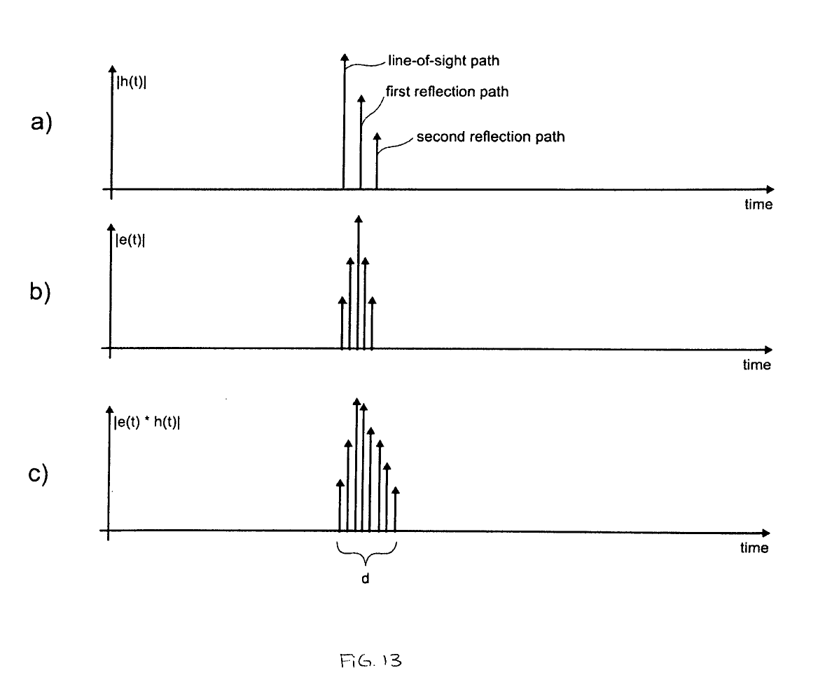

FIG. 13 illustrates the effect of equalizer impulse response. FIG. 13a shows a channel impulse response, similar to FIG. 12a. The impulse response of an equalizer |e(t)| is shown in FIG. 13b. The impulse response of the equalized channel results as the convolution product of both impulse responses and is illustrated in FIG. 13c. Typically, the duration d of the resulting impulse response is much shorter than the duration of a transmission symbol, and intersymbol interference remains localized.

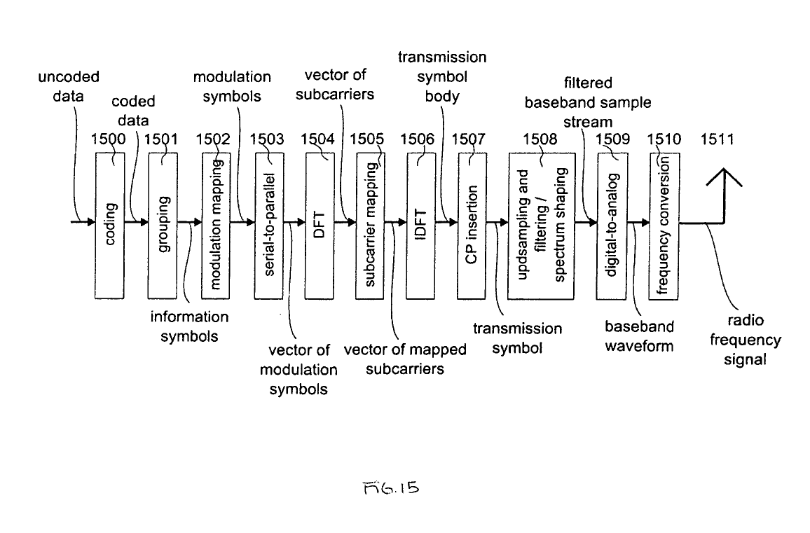

FIG. 15 illustrates a conventional SC-FDMA transmitter. As shown in FIG. 15, the transmitter can receive at an input an uncoded data stream. Coding can be applied in a block 1500 based on transmission parameters, such as a particular modulation and coding scheme. The resultant coded data stream can be grouped according to bits as information symbols in a block 1501. Next, based on transmission parameters, the information symbols can be mapped to a modulation symbol from a modulation constellation or alphabet in a block 1502. A predetermined number of modulation symbols can be combined to a vector of modulation symbols in serial-to-parallel converter block 1503. Next, Discrete Fourier Transform (DFT) may be applied in block 1504, resulting in a vector of subcarriers. Subsequently, subcarrier mapping may be applied in block 1505. The resulting vector of mapped subcarriers may be transformed back to a transmission symbol body by Inverse Discrete Fourier Transform block 1506. A part of the transmission symbol body may be replicated by block 1507 to form a cyclic prefix. Block 1507 may perform similar functions such as the insertion of a cyclic postfix and/or a guard period. Block 1507 may perform a windowing operation. The resulting transmission symbol may be converted to a higher sample rate and filtered in block 1508.The resulting filtered baseband sample stream may be converted to one or more analog waveforms by digital-to-analog converter 1509. The resulting baseband (or intermediate-frequency) waveform may be frequency-converted in block 1510 to a radio frequency signal and coupled to a radio channel in block 1511.

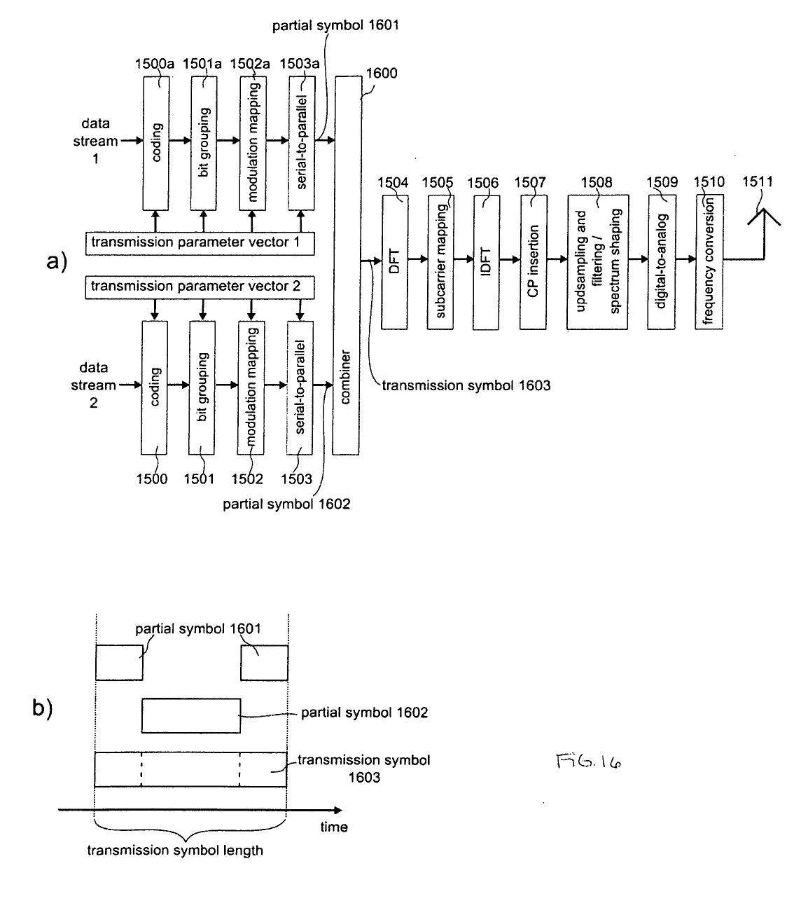

FIG. 16a illustrates a transmitter according to certain embodiments of the present invention. Numerals 1500-1511 refer to blocks with similar functionality as in FIG. 15. Blocks 1500a-1503a perform a similar role to blocks 1500-1503 on a second data stream. As illustrated in FIG. 16a, the modulation and coding of a first data stream and a second data stream corresponding to first and second parts of a transmission symbol can be performed separately, and the products of the separate modulation and coding schemes can be combined after serial to parallel conversion to provide a combined transmission symbol with more optimized transmission characteristics. Although only two data streams are shown, there is no requirement that only two data streams be used. If desired, the transmission symbol could be composed of many parts, each having its own corresponding data stream. FIG. 16b shows partial symbols 1601 and 1602, and the resulting transmission symbol 1603 provided by combiner 1600.

Thus, a radio transmitter can be provided that maps several data streams into predetermined groups of samples in a transmission symbol and chooses a separate modulation-and-coding scheme for each stream according to an SNR estimate for each group of samples. In such a transmitter data streams can be assigned to different hybrid automatic repeat request (HARQ) processes.

In a HARQ process there is repeated retransmission of data on request, until decoding succeeds. There are two main ways in which this can be done: chase combining and incremental redundancy. In chase combining, every retransmission contains the same information, primarily in the form of data and parity bits. In contrast, in incremental redundancy every retransmission contains different information than the prior one. Thus, in incremental redundancy, at every retransmission, the receiver gains extra information.

At least in the case of chase combining it is should be appreciated that the modulation-and-coding scheme cannot conventionally be changed while HARQ retransmissions are ongoing. Therefore, the transmission parameter vector employed in certain embodiments of the present invention may be controlled by a HARQ processor. Chase combining often involves an estimate of the SNRs of signals (maximum-ratio combining). Therefore, an SNR estimate should be available from a HARQ processor, which can then be further employed to determine modulation-and-coding schemes and transmission power levels.

Further, some classes of codes (for example Turbo codes) require an SNR estimate at the decoder to function correctly, and implement SNR estimation. SNR estimation may be implemented for example by identifying known features in the signal, or by analyzing a residual signal after successful decoding of a data message.

One way, in general, that the SNR estimate can be made is through information provided from the receiving end of a radio link or other communication link through a transmission medium. Thus a transmitter in accordance with certain embodiments of the present invention may work in conjunction with a radio receiver at the opposite end of a communication link. The radio receiver can estimate a time-varying signal-to-noise ratio (SNR) over the length of a transmission symbol (for example, over at least one predetermined time interval of the transmission symbol, relative to a start of the transmission symbol) and provide the estimate to a transmitter at the other end of a radio link. In certain embodiments, the length of a transmission symbol body is processed using DFT at the receiver. That estimate can then serve as a transmission environment parameter for the transmitter in deciding which modulation-and-coding scheme, as well as transmission power level, to use. Specifically, the radio transmitter that receives the time-varying SNR estimate can schedule radio transmissions based on the time-varying SNR estimate.

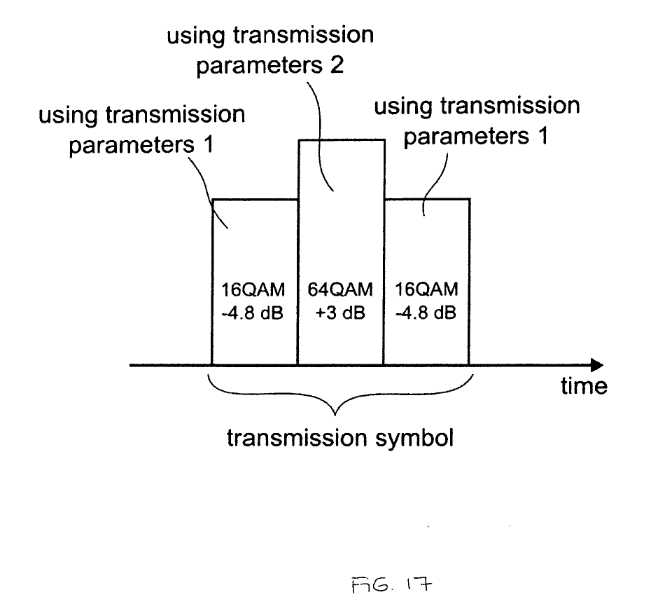

FIG. 17 illustrates the composition of a transmission symbol according to an embodiment of the present invention. The transmission symbol includes a first portion at the head and tail of the transmission symbol and a second portion in the center of the transmission symbol. The first portion has been modulated using 16QAM and the second portion has been coded using 64QAM. Additionally, the power level for the second portion is higher than the power level for the first portion.

Depending on the channel delay profile, the contribution to intersymbol interference by different portions of the symbol may be different. Therefore, another benefit of assigning individual power levels to portions of the symbol is that it permits control of the amount of generated intersymbol interference. There exists, for a particular channel, one or more optimal power envelopes that maximize capacity by controlling the level and location of intersymbol interference. In certain embodiments of the present invention, an estimate of the transmission environment parameters can permit an approximation of an optimal power envelope, for example by appropriately reducing the power level of the head and tail sections of a symbol and increasing the power level of the center of the symbol.

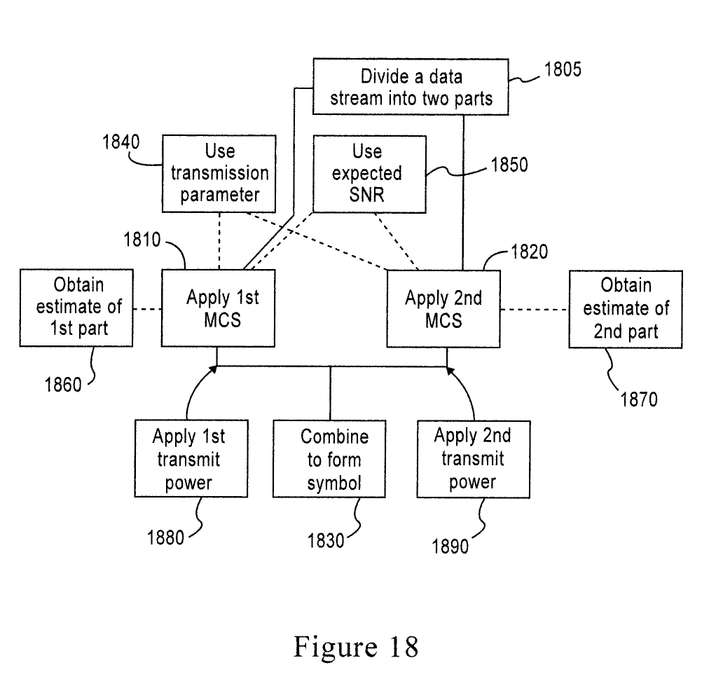

FIG. 18 illustrates a method according to an embodiment of the present invention. As shown in FIG. 18, the method includes applying 1810 a first modulation and coding scheme to a first part of a symbol. The method also includes applying 1820 a second modulation and coding scheme to a second part of the symbol. The method further includes combining 1830 the first part of the symbol and the second part of the symbol to form the symbol to be transmitted. In certain embodiments the transmission may take place on a single physical channel. The first modulation and coding scheme can differ from the second modulation and coding scheme and the first part of the symbol can be different from the second part of the symbol. The first part of the symbol can be the head and the tail of the symbol, and the second part of the symbol can be the middle of the symbol. Thus the first part of the symbol is temporally different from the second part of the symbol. It should be noted that “temporally different” can mean that first part precedes the second part (in time), that the first part follows the second part (in time) or that the first part both precedes and follows the second part (in time).

The method can also include selecting 1840 at least one of the first modulation and coding scheme or the second modulation and coding scheme based on a respective transmission environment parameter depending on the transmission context of the corresponding part of the symbol. The transmission context can be, for example, the channel delay profile and the resulting intersymbol interference (ISI). Thus, a transmission environment parameter, such as SNR, can contrast with a transmission parameter, such as the specific modulation and coding scheme. The method can also include selecting 1850 at least one of the first modulation and coding scheme or the second modulation and coding scheme based on an expected SNR of the corresponding part of the symbol.

The method can further include obtaining 1860 an estimate of a first transmission environment parameter for the first part of the symbol and obtaining 1870 an estimate of a second transmission environment parameter for the second part of the symbol. The application of the first modulation and coding scheme can be based on the first transmission environment parameter and the application of the second modulation and coding scheme can be based on the second transmission environment parameter.

The method can additionally include applying 1880 a first transmit power to the first part of the symbol and applying 1890 a second transmit power to a second part of the symbol. The first transmit power can be different from the second transmit power.

The method can also include dividing 1805 a data stream into a plurality of data streams. Then the applying the first modulating and coding scheme can be performed on a first data stream of the plurality of streams and the applying the second modulating and coding scheme can be performed on a second data stream of the plurality of streams.

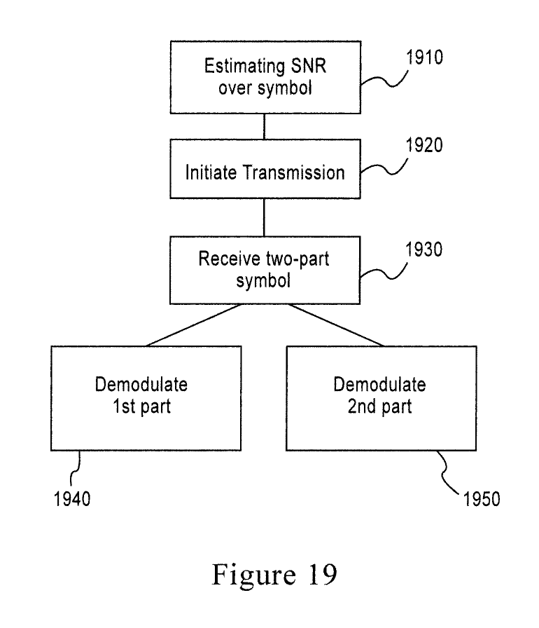

FIG. 19 illustrates another method according to an embodiment of the present invention. The method includes estimating 1910 a time-varying SNR over at least one predetermined time interval of a transmission symbol, relative to a start of the transmission symbol, at a receiver. The method also includes initiating 1920 transmission of the estimate to a transmitter at an opposite end of a radio link from the receiver. The estimating can be done on the basis of an average of a large number (for example, 100) of received symbols.

The method can also include receiving 1930 a transmission symbol comprising a first part and a second part, demodulating 1940 the first part of the transmission symbol according to a first modulation and coding scheme, and demodulating 1950 the second part of the transmission symbol according to a second modulation and coding scheme. The first modulation and coding scheme can differ from the second modulation and coding scheme.

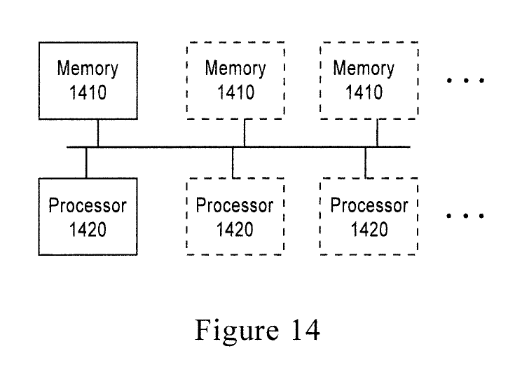

FIG. 14 illustrates an apparatus according to an embodiment of the present invention. The apparatus includes at least one memory 1410 including computer program code. The apparatus also includes at least one processor 1420. The at least one memory 1410 and the computer program code are configured to, with the at least one processor 1420, cause the apparatus at least to perform a process. The process may be, for example, the method illustrated in FIG. 18 or the method illustrated in FIG. 19.

The memory 1410 can be any storage device, such as a computer-readable medium. The storage device may be in the form of Random Access Memory (RAM), on-chip memory of the processor 1420, or even optical memory, such as a Compact Disc (CD-ROM). These examples are illustrative, and not intended to limit.

The processor 1420 can be, for example, a controller, central processing unit (CPU) or digital signal processor (DSP). Similar circuitry may also be utilized. The processor 1420 can be a general purpose processor that is customized for the particular practice of the present invention, or it can be implemented on an Application Specific Integrated Circuit (ASIC) or a field-programmable gate array (FPGA), for example. One way to customize a general purpose processor is by providing it with instructions from software. The software can be stored in a non-transient computer-readable medium. The processor can be a multi-core processor, and can employ either a single or multiple chip implementation. In certain embodiments the processor 1420 and the memory 1410 are on a single chip.

Certain embodiments of the present invention relate to a method of transmitting data over a bandlimited channel. The method includes selecting a transmission parameter vector based at least partly on a position of an information symbol in a set of information symbols. The method also includes mapping the information symbol to a modulation symbol using the selected transmission parameter vector. The method further includes combining a plurality of modulation symbols in a transmission symbol. The method additionally includes transmitting the transmission symbol over a transmission medium.

The selection of the transmission parameter vector can be based at least partly on a vector of channel quality estimates at a receiving node. The vector of channel quality estimates can include a plurality of channel quality estimates in predetermined time intervals, relative to the start time of a transmission symbol. Channel quality estimates can be provided at least partly by a HARQ processor at a receiving node. A control channel of a wireless link can be used to provide channel quality estimates.

The method can involve mapping a plurality of modulation symbols adjacent in a transmission symbol from information symbols using a common transmission parameter vector. As to the individual transmission parameter vectors, one transmission parameter vector can be used in the middle of a transmission symbol, and another vector for the remainder of the transmission symbol.

A plurality of information symbols mapped to modulation symbols adjacent in a transmission symbol can be provided by one data stream in a plurality of data streams. Different data streams of the plurality of data streams can carry data of different HARQ processes

Transmitting the transmission symbol can include modulating a carrier wave with the transmission symbol and coupling the modulated carrier wave to a transmission medium. Transmitting the transmission symbol can also include shaping the spectrum of the transmission symbol with a filter. Combining a plurality of modulation symbols in a transmission symbol can also include insertion of a cyclic prefix.

The preceding discussion has discussed embodiments of the present invention from the standpoint of wireless communication systems. One of ordinary skill in the art of communications system will recognize, however, that the techniques and technologies employed are not necessarily limited strictly to wireless systems.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
applying a first modulation and coding scheme to a first part of a symbol;
applying a second modulation and coding scheme to a second part of the symbol; and
combining the first part of the symbol and the second part of the symbol to form the symbol to be transmitted,
wherein the first modulation and coding scheme differs from the second modulation and coding scheme and wherein the first part of the symbol is temporally different from the second part of the symbol.

2. The method of claim 1, further comprising:
selecting at least one of the first modulation and coding scheme or the second modulation and coding scheme based on a respective transmission environment parameter depending on a transmission context of a corresponding part of the symbol.

3. The method of claim 1, further comprising:
selecting at least one of the first modulation and coding scheme or the second modulation and coding scheme based on an expected signal-to-noise ratio of a corresponding part of the symbol.

4. The method of claim 1, further comprising:
obtaining an estimate of a first transmission environment parameter for the first part of the symbol; and
obtaining an estimate of a second transmission environment parameter for the second part of the symbol,
wherein application of the first modulation and coding scheme is based on the first transmission environment parameter and application of the second modulation and coding scheme is based on the second transmission environment parameter.

5. The method of claim 1, further comprising:
applying a first transmit power to the first part of the symbol; and
applying a second transmit power to a second part of the symbol,
wherein the first transmit power is different from the second transmit power.

6. The method of claim 1, wherein the applying the first modulation and coding scheme to the first part of the symbol comprises applying the first modulation and coding scheme to the head and the tail of the symbol, and wherein the applying the second modulation and coding scheme to the second part of the symbol, comprises applying the second modulation and coding scheme to the middle of the symbol.

7. The method of claim 1, further comprising:
dividing a data stream into a plurality of data streams;
performing the applying the first modulating and coding scheme on a first data stream of the plurality of streams; and
performing the applying the second modulating and coding scheme on a second data stream of the plurality of streams.

8. An apparatus, comprising:
at least one memory including computer program code;
at least one processor,
wherein the at least one memory and the computer program code are configured to, with the at least one processor, cause the apparatus at least to perform
apply a first modulation and coding scheme to a first part of a symbol;
apply a second modulation and coding scheme to a second part of the symbol; and
combine the first part of the symbol and the second part of the symbol to form the symbol to be transmitted,
wherein the first modulation and coding scheme differs from the second modulation and coding scheme and wherein the first part of the symbol is temporally different from the second part of the symbol.

9. The apparatus of claim 8, wherein the at least one memory and the computer program code are further configured to, with the at least one processor, cause the apparatus at least to perform:
select at least one of the first modulation and coding scheme or the second modulation and coding scheme based on a respective transmission environment parameter depending on the transmission context of the corresponding part of the symbol.

10. The apparatus of claim 8, wherein the at least one memory and the computer program code are further configured to, with the at least one processor, cause the apparatus at least to perform:
select at least one of the first modulation and coding scheme or the second modulation and coding scheme based on an expected signal-to-noise ratio of the corresponding part of the symbol.

11. The apparatus of claim 8, wherein the at least one memory and the computer program code are further configured to, with the at least one processor, cause the apparatus at least to perform:
obtain an estimate of a first transmission environment parameter for the first part of the symbol; and
obtain an estimate of a second transmission environment parameter for the second part of the symbol,
wherein application of the first modulation and coding scheme is based on the first transmission environment parameter and application of the second modulation and coding scheme is based on the second transmission environment parameter.

12. The apparatus of claim 8, wherein the at least one memory and the computer program code are further configured to, with the at least one processor, cause the apparatus at least to perform:
apply a first transmit power to the first part of the symbol; and
apply a second transmit power to a second part of the symbol,
wherein the first transmit power is different from the second transmit power.

13. The apparatus of claim 8, wherein the first part of the symbol comprises the head and the tail of the symbol, and wherein the second part of the symbol comprises the middle of the symbol.

14. The apparatus of claim 8, wherein the at least one memory and the computer program code are further configured to, with the at least one processor, cause the apparatus at least to perform:
divide a data stream into a plurality of data streams;
perform the applying the first modulating and coding scheme on a first data stream of the plurality of streams; and
perform the applying the second modulating and coding scheme on a second data stream of the plurality of streams.

15. A method, comprising:
estimating a time-varying signal-to-noise ratio over at least one predetermined time interval of a transmission symbol, relative to a start of the transmission symbol, at a receiver to yield an estimate; and
initiating transmission of the estimate to a transmitter at an opposite end of a communication link from the receiver.

16. The method of claim 15, wherein the estimating is done based on an average of a large number of received symbols.

17. The method of claim 15, further comprising:
receiving a transmission symbol comprising a first part and a second part;
demodulating the first part of the transmission symbol according to a first modulation and coding scheme; and
demodulating the second part of the transmission symbol according to a second modulation and coding scheme,
wherein the first modulation and coding scheme differs from the second modulation and coding scheme.

18. An apparatus, comprising:
at least one memory including computer program code; and
at least one processor,
wherein the at least one memory and the computer program code are configured to, with the at least one processor, cause the apparatus at least to perform
estimate a time-varying signal-to-noise ratio over at least one predetermined time interval of a transmission symbol, relative to a start of the transmission symbol, to yield an estimate; and
initiate transmission of the estimate to a transmitter at an opposite end of a communication link from the apparatus.

19. The apparatus of claim 18, wherein the at least one memory and the computer program code are further configured to, with the at least one processor, cause the apparatus at least to estimate the signal-to-noise ratio based on an average of a large number of received symbols.

20. The apparatus of claim 18, wherein the at least one memory and the computer program code are further configured to, with the at least one processor, cause the apparatus at least to perform:
receive a transmission symbol comprising a first part and a second part;
demodulate the first part of the transmission symbol according to a first modulation and coding scheme; and
demodulate the second part of the transmission symbol according to a second modulation and coding scheme,
wherein the first modulation and coding scheme differs from the second modulation and coding scheme.
